(19) United States
(12) Patent Application Publication
(10) Pub. No.: US 2007/0059402 A1
(43) Pub. Date: Mar. 15, 2007

(54) Carbon monoxide modified atmosphere packaging having a time temperature indicator

(75) Inventor: Charles Rice Barmore, Moore, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Cryovac, Inc.

(21) Appl. No.: 11/225,564

(22) Filed: Sep. 13, 2005

(51) Int. Cl. A22C 17/10

(52) U.S. Cl. 426/87

(57) ABSTRACT

The invention is a modified atmosphere package comprising about 0.1 to 5 vol. % carbon monoxide and that includes a time-temperature indicator that is disposed in a temperature monitoring relationship with the package and that is configured to indicate whether a perishable product disposed in the package has been exposed to a time-temperature exposure that may have caused spoilage of the product. The time-temperature indicator may be used to alert a person that a red meat product disposed in the package has potentially spoiled even though the meat product may have a fresh “bloomed” appearance. As a result, the possibility of a consumer purchasing a spoiled product may be reduced. The invention is also directed to a method of using the time-temperature indicator to indicate the likelihood of spoilage in the packaged product. In one embodiment, the time-temperature indicator changes visual appearance based on a combination of predetermined times and temperatures.

### BACKGROUND OF THE INVENTION

The invention relates generally to modified atmosphere packaging and more particularly to a modified atmosphere packaging comprising a mixture of gases that includes carbon monoxide.

The butchering and packaging of meat products has undergone many changes. Historically, meat products have been butchered and packaged in each supermarket. This arrangement has generally been recognized as inefficient and expensive. In recent years, there has been trend to butcher and package meat products at a centralized location. The packaged meat may then be shipped to a retailer for sale. In some cases, the meat product may be packaged in a so-called “case-ready” package that may be packaged according to a retailer's specifications. Upon reaching the retailer, the case-ready package may be ready for immediate display at the point of sale.

Consumer demand for fresh naturally preserved food products, such as meat, has continued to grow. To meet this demand, it may be desirable to enclose the food product in a modified atmosphere packaging (MAP). MAP comprises packaging the food product in an atmosphere that has been modified to extend the shelf-life and/or improve the appearance of the packaged product. The appearance of a meat product is generally very important at the point of purchase. Common gases that may be used in MAP include oxygen, carbon dioxide, and nitrogen.

In MAP applications, the raw meat may be packaged in either a high level or low level oxygen (O₂) environment. Packaging systems which provide low levels of oxygen are generally preferable because the fresh quality of meat can be preserved longer under anaerobic conditions than under aerobic conditions. Maintaining low levels of oxygen minimizes the growth and multiplication of aerobic bacteria. One example of a modified atmosphere environment is a mixture of gases consisting of about 30 percent carbon dioxide (CO₂) and about 70 percent nitrogen (N₂). Typically, low oxygen packaging environments may provide an atmosphere that helps prevent or inhibit excessive metmyoglobin (brown) formation. In a low level oxygen environment, the raw meat may have a less desirable purple-red color which few consumers would associate with freshness. The deoxymyoglobin (purple-red color) is generally unacceptable to most consumers. Deoxymyoglobin is a precursor protein which when oxygenated forms oxymyoglobin in a normal atmosphere of oxygen. Oxymyoglobin is responsible for the bright red color of meat which most consumers associate with freshness

Fresh red meat presents a particular challenge to the concept of centralized processing and packaging due to its oxygen-sensitivity as manifested primarily in the shelf-life and appearance (color) of a packaged meat product. For example, while a low-oxygen packaging environment generally increases the shelf-life of a packaged meat product (relative to meat products packaged in an environment having a higher oxygen content), red meat has a tendency to assume the purple-red color when packaged in the absence of oxygen or in an environment having a very low oxygen concentration, i.e., below about 0.1% oxygen. Unfortunately, such a purple-red color may be undesirable to most consumers. When meat is exposed to a sufficiently high concentration of oxygen, e.g., as found in air, it assumes a bright red color. After 1 to 5 days of such exposure, in a lighted display case, the meat may assume a brown color which, like the purple color, is undesirable to most consumers.

Carbon monoxide has been used in MAP to help maintain the desired appearance of the meat product. Carbon monoxide binds to myoglobin, a protein present in red meat, to form carboxymyoglobin. The formation of carboxymyoglobin produces a bright red or cherry red color within the meat. The carboxymyoglobin pigment is generally more stable against oxidative discoloratin than oxymyoglobin. As a result, a MAP environment including carbon monoxide helps the raw meat maintain a “bloomed” appearance for an extended length of time.

One possible disadvantage of maintaining meat in a carbon monoxide atmosphere package is the possibility of masking the appearance spoilage. In a non-barrier or high oxygen packaging environment, the presence of the oxygen generally causes the meat to have a brown coloring after a certain amount of time. Consumers may use color as an indication of the freshness of the meat product even though color is not necessarily correlated with microbial growth. Because discoloration may precede microbial spoilage in an aerobic (high oxygen MAP or non-barrier) environment, a consumer is less likely to purchase a spoiled meat product. If microbial spoilage has occurred, distinct off odors may be detected by the consumer or retailer. In a low oxygen MAP package, the spoilage of the meat may not be detectable until after the package has been opened. As a result, a consumer may purchase a packaged meat product having an appearance of freshness only to realize upon opening the package at home that the meat has spoiled.

In an attempt to avoid selling a spoiled product, many packagers may mark the packaged product with a printed expiration date in an attempt to provide an indication of when the useful life of the product ends. The expiration date is an estimate based on assumptions about the thermal history of the product that may not be true with respect to a particular package on which they appear. If the actual temperatures of exposure are higher than those used in determining the printed expiration date, the perishable item may degrade or spoil before the marked expiration date. As a result, the printed expiration date may mislead a consumer into believing the product is still usable when in fact it was past its useful life.

Thus, there exists a need to determine the likelihood of spoilage of a food product packaged in modified atmosphere package that comprise carbon monoxide.

### BRIEF SUMMARY OF THE INVENTION

The invention is directed to a modified atmosphere packaging comprising carbon monoxide and that includes a time-temperature indicator that is configured to indicate whether a perishable product disposed in the package has been exposed to a time-temperature exposure that may have resulted in spoilage of the product. In one embodiment, the time-temperature indicator may be used to alert a person that a red meat product disposed in the package has potentially spoiled even though the meat product may have a fresh “bloomed” appearance. As a result, the possibility of a consumer purchasing a spoiled product may be reduced. A second aspect of the invention is directed to a method of using the time-temperature indicator to indicate the likelihood of spoilage in the packaged product.

In one embodiment, the invention may comprise a substantially oxygen impermeable package comprising an interior space configured to enclose a food product therein and a mixture of gases comprising from about 0.1 to 5.0 vol. % carbon monoxide and at least one other gas to form a low oxygen environment at the time of packaging. A time-temperature indicator may be disposed in a temperature monitoring relationship with the package. In one embodiment, the time-temperature indicator changes visual appearance based on a combination of predetermined times and temperatures.

Thus, the invention provides a means to help determine if a perishable food product packaged in a low oxygen atmosphere comprising at least 0.1 vol. % carbon monoxide may have been exposed to a time-temperature exposure that may resulted in spoilage of the food product.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a graphical illustration of a modified atmosphere package containing a meat product and having an associated time-temperature indicator;

FIG. 2 is a graphical illustration of a carton having a plurality of the modified atmosphere package depicted in FIG. 1 and a time-temperature indicator disposed in the interior of the carton; and

FIG. 3 is a graphical illustration of a flexible package having a plurality of the modified atmosphere package depicted in FIG. 1 and a time-temperature indicator disposed in the interior of the flexible package.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

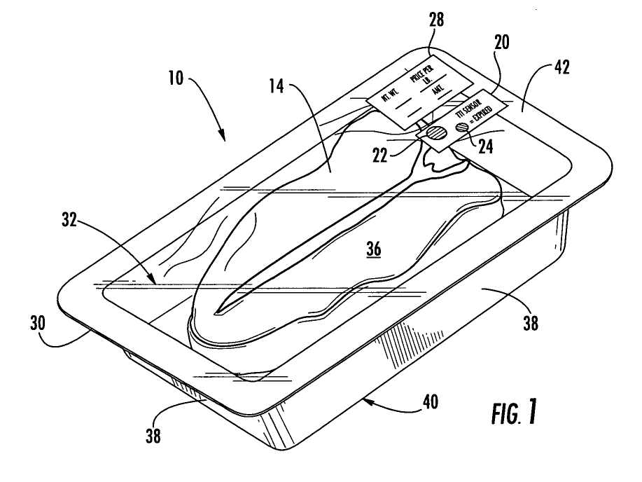

With reference to FIG. 1, a modified atmosphere package comprising a low oxygen atmosphere and carbon monoxide and an associated time-temperature indicator is illustrated and broadly designated as reference number 10. In one alternative embodiment, the package 10 may include a package having an interior space or cavity 32 in which a food product 14 may be disposed, and an associated time-temperature indicator (TTI) 20 disposed in a temperature monitoring relationship with the package 10. The time-temperature indicator may be configured to visually indicate an exposure history to which the package has been exposed. The time-temperature indicator may then be used to determine if the package has been exposed to a time-temperature exposure that may have resulted in spoilage of the product. In the illustrated embodiment, the time-temperature indicator comprises a label having an indicator 22 that changes color if the temperature exceeds a predetermined threshold. In one alternative embodiment, the time-temperature indicator may include a reference scale or mark 24 that may be used for making a comparison with the indicator 22 to determine if the temperature may have exceeded the predetermined threshold. The term “package” as used herein shall be defined as any means for holding a perishable food product, such as raw meat, including a container, carton, casing parcel, holder, tray, flat, bag, film, envelope, etc.

The package 10 may include a low oxygen modified atmosphere comprising a mixture of gases that comprise from about 0.1 to 5.0 vol. % carbon monoxide. In one embodiment, the low oxygen atmosphere may include from about 0.1 to 3.0 vol. % carbon monoxide. In some embodiments, the low oxygen atmosphere may include at least 0.1 vol. % carbon monoxide. In another embodiment, the low oxygen atmosphere may include at least 0.3 vol. % carbon monoxide. The low oxygen environment helps to suppress the growth of aerobic bacteria and helps prevent or inhibit excessive metmyoglobin (brown) formation. In red meat products, the carbon monoxide in the package reacts with myoglobin to form carboxymyoglobin to produce a cherry red color, and may maintain this red color while packaged in a low oxygen environment. The cherry red color may be maintained from packaging through retail display. The carbon monoxide modified atmosphere may include the benefits of a low oxygen environment while presenting a bright red appearance, which may be desirable to consumers. The modified atmosphere packaging enables a storage period of from 1 to about 30 days prior to retail display. In one alternative embodiment, a food item such as a retail cut of raw meat may be disposed in the package 10. In some embodiments, the raw meat may be any animal protein, including beef, pork, veal, lamb, chicken, turkey, venison, fish, etc.

Examples of low oxygen environments include, but are not limited, to about 30 vol. % carbon dioxide and about 70 vol. % nitrogen, with up to about 5% vol. carbon monoxide. It is contemplated that other combinations of carbon dioxide and nitrogen may be used. For example, the low oxygen environment may include from about 40 to about 80 vol. % nitrogen and from about 20 to about 60 vol. % carbon dioxide. The low oxygen environment may include from about 0.1 vol. % to about 3.0 vol. % carbon monoxide. In one alternative embodiment, the modified atmosphere may comprise about 0.4% vol. carbon monoxide, about 30% vol. carbon dioxide, with nitrogen comprising the remaining balance. In some embodiments, the modified atmosphere may include additional gases in the mixture, for example, one or more noble gases.

The modified atmosphere packaging of the present invention is believed to protect the pigment myoglobin on or near the surface of the meat during the oxygen reduction phase, allowing the meat to have a desired display color (i.e., a full bloom). While not being bound by theory, it is believed that the low level of carbon monoxide in the gas mixture forms carboxymyoglobin (red) and protects the myoglobin from reaching the metmyoglobin (brown) or deoxymyoglobin (purple-red) state during storage and/or display. Before converting to carboxymyoglobin, a surface of the meat may be at least partially oxygenated (oxymyoglobin). By converting to carboxymyoglobin on at least the surface of the meat, the myoglobin is protected during the oxygen reduction period when it is vulnerable to the formation of metmyoglobin. This protection is especially important from about 2 vol. % to about 500 or 1000 ppm oxygen when metmyoglobin forms rapidly. The myoglobin pigment of the meat is also protected by the mixture of gases used in the present invention even when the meat is stored in a foam tray that may slowly diffuse oxygen when packaged in a low oxygen package.

In one alternative embodiment, the package 10 may include product support member 30 having a cavity 32 or interior space formed therein and a product 14 disposed within the cavity. Support member 30 may be in the form of a tray having side walls 38 and a base 40 which define the cavity 34, and further may include a peripheral flange 42 extending outwardly from the cavity. Lidstock 36 forms a lid on the package 10 and encloses the product 34 within cavity 32 by being heat-welded or otherwise bonded to flange 42. In some embodiments, the lidstock 36 may be attached to the support member using other means including adhesive bonding, ultrasonic bonding, etc. In one embodiment, the package 10 may include a label 28 that may include product information, such as pricing, description, expiration date, etc. Label 28 may be placed on the package at the point of packaging or by the retailer at the point-of-sale.

Support member 30 can have any desired configuration or shape, e.g., rectangular, round, oval, etc. Similarly, flange 42 may have any desired shape or design, including a simple, substantially flat design which presents a single sealing surface as shown, or a more elaborate design which presents two or more sealing surfaces, such as the flange configurations disclosed in U.S. Pat. Nos. 5,348,752 and 5,439,132, the disclosures of which are hereby incorporated herein by reference.

Suitable materials from which support member 30 can be formed may include, without limitation, polyvinyl chloride, polyethylene terephthalate, polystyrene, polyolefins such as high density polyethylene or polypropylene, paper pulp, nylon, polyurethane, and combinations thereof. The support member may be foamed or non-foamed (e.g., solid or semi-solid) as desired. Support member 30 may have oxygen transmission barrier attributes, particularly when product 14 is an oxygen-sensitive food product. When such oxygen-sensitive products are to be packaged in a modified atmosphere environment to extend either bloom-color life or shelf-life, support member 30 may have a thickness and composition sufficient to provide an oxygen transmission rate of no more than about any of the following values: 1000, 500, 150, 100, 50, 45, 40, 35, 30, 25, 20, 15, 10, and 5 cubic centimeters (at standard temperature and pressure) per square meter per day per 1 atmosphere of oxygen pressure differential measured at 0% relative humidity and 23° C. Unless otherwise stated all references to oxygen transmission rate are measured according to ASTM D-3985.

To achieve oxygen barrier attributes, support member 30 may comprise one or more oxygen barrier components, such as a substantially oxygen impermeable film or laminate in order to provide oxygen barrier attributes to the support member. Such barrier components may be incorporated within structural sections or aspects of the support member—or optionally incorporated in an inner surface layer or film (not shown) laminated or otherwise bonded to form the inside surface of the support member, as described in U.S. Pat. Nos. 4,847,148 and 4,935,089, and in U.S. Ser. No. 08/326,176, filed Oct. 19, 1994 and entitled “Film/Substrate Composite Material” (published as EP 707 955 A1 on Apr. 24, 1996), each of which is incorporated herein in its entirety by reference.

In addition to (or as an alternative to) providing oxygen barrier attributes, the inner surface layer or film of the support member may enhance the sealability of the lidstock 36 to the support member 30. In heat sealing the lidstock to the support member 30, the surface layer of the support member may contact and meld with an inner surface of the lidstock 36 to form a heat seal. To facilitate a strong heat seal, the surface layer of the support member may comprise one or more thermoplastics that are compatible with the thermoplastic composition of the lidstock 36. In some embodiments, the inner surface layer may also have antifog properties to help enhance the clarity of the film. Suitable antifog additives may include, without limitation, polyglycerol esters, mono and diglycerides and combinations thereof.

The height of the product 14 within the tray may be low profile or high profile. “Low profile” refers to packages wherein the product has a maximum height which is below the maximum height of support member 30, i.e., the level at which flange 42 is located. “High profile” products may also be packaged in accordance with the present invention, i.e., those having a maximum height which is above the level at which flange 42 is located so that the portion of the product which extends above the level of flange 42 will be in contact with lidstock 36.

In one alternative embodiment, the lidstock 36 may comprise a single or multilayer film or laminate which is substantially impermeable to oxygen. In one embodiment, the lidstock may comprise a laminate comprising two or more films. The film(s) may be monolayer, two-layer, or have three or more layers. The lidstock 36 may be laminated to the support member (e.g., a tray) to form sealed package 10 in which a food product 14 may be enclosed.

In one alternative embodiment, the lidstock may comprise a film having one or more barrier layers, which incorporate one or more components (“barrier components”) that markedly decrease the oxygen transmission rate through the layer and thus the film incorporating such layer. Accordingly, the barrier layer of the film that is utilized in a lidstock incorporated in a package may either help to exclude oxygen from the interior of the package—or to maintain a modified atmosphere within the package. In one embodiment, the lidstock may have a thickness and composition sufficient to provide an oxygen transmission rate of no more than about any of the following values: 1000, 500, 150, 100, 50, 45, 40, 35, 30, 25, 20, 15, 10, and 5 cubic centimeters (at standard temperature and pressure) per square meter per day per 1 atmosphere of oxygen pressure differential measured at 0% relative humidity and 23° C.

Useful barrier components may include: ethylene/vinyl alcohol copolymer (“EVOH”), polyvinyl alcohol (“PVOH”), vinylidene chloride polymers (“PVdC”), polyalkylene carbonate, polyester (e.g., PET, PEN), polyacrylonitrile (“PAN”), and polyamide. In some embodiments the lidstock may also include one or more thermoplastic polymers including polyolefins, polystyrenes, polyurethanes, polyvinyl chlorides, polyesters, and ionomers provided that the desired barrier properties of the lidstock may be maintained.

Suitable polyolefins for use in the lidstock may include LLDPE, low density polyethylene, high density polyethylene, metallocene catalyzed polyethylene, polypropylene, and oriented polypropylene, ethylene homo- and co-polymers and propylene homo- and co-polymers. Ethylene homopolymers include high density polyethylene (“HDPE”) and low density polyethylene (“LDPE”). Ethylene copolymers include ethylene/alpha-olefin copolymers (“EAOs”), ethylene/unsaturated ester copolymers, and ethylene/(meth)acrylic acid. (“Copolymer” as used in this application means a polymer derived from two or more types of monomers, and includes terpolymers, etc.).

EAOs are copolymers of ethylene and one or more alpha-olefins, the copolymer having ethylene as the majority mole-percentage content. In some embodiments, the comonomer includes one or more C₃-C₂₀ alpha-olefins, more preferably one or more C₄-C₁₂ alpha-olefins, and most preferably one or more C₄-C₈ alpha-olefins. Particularly useful alpha-olefins include 1-butene, 1-hexene, 1-octene, and mixtures thereof.

EAOs include one or more of the following: 1) medium density polyethylene (“MDPE”), for example having a density of from 0.93 to 0.94 g/cm³; 2) linear medium density polyethylene (“LMDPE”), for example having a density of from 0.926 to 0.94 g/cm³; 3) linear low density polyethylene (“LLDPE”), for example having a density of from 0.915 to 0.930 g/cm3; 4) very-low or ultra-low density polyethylene (“VLDPE” and “ULDPE”), for example having density below 0.915 g/cm³; and 5) homogeneous EAOs. Useful EAOs include those having a density of less than about any of the following: 0.925, 0.922, 0.92, 0.917, 0.915, 0.912, 0.91, 0.907, 0.905, 0.903, 0.9, and 0.898 grams/cubic centimeter. Unless otherwise indicated, all densities herein are measured according to ASTM D1505.

The polyethylene polymers may be either heterogeneous or homogeneous. As is known in the art, heterogeneous polymers have a relatively wide variation in molecular weight and composition distribution. Heterogeneous polymers may be prepared with, for example, conventional Ziegler Natta catalysts.

On the other hand, homogeneous polymers are typically prepared using metallocene or other single site-type catalysts. Such single-site catalysts typically have only one type of catalytic site, which is believed to be the basis for the homogeneity of the polymers resulting from the polymerization. Homogeneous polymers are structurally different from heterogeneous polymers in that homogeneous polymers exhibit a relatively even sequencing of comonomers within a chain, a mirroring of sequence distribution in all chains, and a similarity of length of all chains. As a result, homogeneous polymers have relatively narrow molecular weight and composition distributions. Examples of homogeneous polymers include the metallocene-catalyzed linear homogeneous ethylene/alpha-olefin copolymer resins available from the Exxon Chemical Company (Baytown, Tex.) under the EXACT trademark, linear homogeneous ethylene/alpha-olefin copolymer resins available from the Mitsui Petrochemical Corporation under the TAFMER trademark, and long-chain branched, metallocene-catalyzed homogeneous ethylene/alpha-olefin copolymer resins available from the Dow Chemical Company under the AFFINITY trademark.

Another useful ethylene copolymer is ethylene/unsaturated ester copolymer, which is the copolymer of ethylene and one or more unsaturated ester monomers. Useful unsaturated esters include: 1) vinyl esters of aliphatic carboxylic acids, where the esters have from 4 to 12 carbon atoms, and 2) alkyl esters of acrylic or methacrylic acid (collectively, “alkyl (meth)acrylate”), where the esters have from 4 to 12 carbon atoms.

Representative examples of the first (“vinyl ester”) group of monomers include vinyl acetate, vinyl propionate, vinyl hexanoate, and vinyl 2-ethylhexanoate. The vinyl ester monomer may have from 4 to 8 carbon atoms, from 4 to 6 carbon atoms, from 4 to 5 carbon atoms, and preferably 4 carbon atoms.

Representative examples of the second (“alkyl (meth)acrylate”) group of monomers include methyl acrylate, ethyl acrylate, isobutyl acrylate, n-butyl acrylate, hexyl acrylate, and 2-ethylhexyl acrylate, methyl methacrylate, ethyl methacrylate, isobutyl methacrylate, n-butyl methacrylate, hexyl methacrylate, and 2-ethylhexyl methacrylate. The alkyl (meth)acrylate monomer may have from 4 to 8 carbon atoms, from 4 to 6 carbon atoms, and preferably from 4 to 5 carbon atoms.

The unsaturated ester (i.e., vinyl ester or alkyl (meth)acrylate) comonomer content of the ethylene/unsaturated ester copolymer may range from about 3 to about 18 weight %, and from about 8 to about 12 weight %, based on the weight of the copolymer. Useful ethylene contents of the ethylene/unsaturated ester copolymer may include the following amounts: at least about 82 weight %, at least about 85 weight %, at least about 88 weight %, no greater than about 97 weight %, no greater than about 93 weight %, and no greater than about 92 weight %, based on the weight of the copolymer.

Representative examples of ethylene/unsaturated ester copolymers may include ethylene/methyl acrylate, ethylene/methyl methacrylate, ethylene/ethyl acrylate, ethylene/ethyl methacrylate, ethylene/butyl acrylate, ethylene/2-ethylhexyl methacrylate, and ethylene/vinyl acetate. Another useful ethylene copolymer is ethylene/(meth)acrylic acid, which is the copolymer of ethylene and acrylic acid, methacrylic acid, or both.

Useful propylene copolymer may include propylene/ethylene copolymers (“EPC”), which are copolymers of propylene and ethylene having a majority weight % content of propylene, such as those having an ethylene comonomer content of less than 10%, preferably less than 6%, and more preferably from about 2% to 6% by weight.

Ionomer is a copolymer of ethylene and an ethylenically unsaturated monocarboxylic acid having the carboxylic acid groups partially neutralized by a metal ion, such as sodium or zinc, preferably zinc. Useful ionomers may include those in which sufficient metal ion is present to neutralize from about 15% to about 60% of the acid groups in the ionomer. The carboxylic acid is preferably “(meth)acrylic acid”—which means acrylic acid and/or methacrylic acid. Useful ionomers include those having at least 50 weight % and preferably at least 80 weight % ethylene units. Useful ionomers also include those having from 1 to 20 weight percent acid units. Useful ionomers are available, for example, from Dupont Corporation (Wilmington, Del.) under the SURLYN trademark.

In some embodiments, EVOH may have an ethylene content of between about 20% and 40%, preferably between about 25% and 35%, more preferably about 32% by weight. EVOH may include saponified or hydrolyzed ethylene/vinyl acetate copolymers, such as those having a degree of hydrolysis of at least 50%, preferably of at least 85%.

Vinylidene chloride polymer (“PVdC”) refers to a vinylidene chloride-containing polymer or copolymer—that is, a polymer that includes monomer units derived from vinylidene chloride (CH2═CCl2) and also, optionally, monomer units derived from one or more of vinyl chloride, styrene, vinyl acetate, acrylonitrile, and C1-C12 alkyl esters of (meth)acrylic acid (e.g., methyl acrylate, butyl acrylate, methyl methacrylate). As used herein, “(meth)acrylic acid” refers to both acrylic acid and/or methacrylic acid; and “(meth)acrylate” refers to both acrylate and methacrylate. Examples of PVdC include one or more of the following: vinylidene chloride homopolymer, vinylidene chloride/vinyl chloride copolymer (“VDC/VC”), vinylidene chloride/methyl acrylate copolymer, vinylidene chloride/ethyl acrylate copolymer, vinylidene chloride/ethyl methaerylate copolymer, vinylidene chloride/methyl methacrylate copolymer, vinylidene chloride/butyl acrylate copolymer, vinylidene chloride/styrene copolymer, vinylidene chloride/acrylonitrile copolymer, and vinylidene chloride/vinyl acetate copolymer. Useful PVdC may include those having between 75 and 95 weight % vinylidene chloride monomer. Useful PVdC includes that having from about 5 to about 25 weight %, from about 10 to about 22 weight %, and from about 15 to about 20 weight % comonomer with the vinylidene chloride monomer. Useful PVdC includes that having a weight-average molecular weight (Mw) of at least 80,000, such as at least 90,000, at least 100,000, at least 111,000, at least 120,000, at least 150,000, and at least 180,000; and between 80,000 and 180,000, such as between 90,000 and 170,000, between 100,000 and 160,000, between 111,000 and 150,000, and between 120,000 and 140,000. Useful PVdC may also include that having a viscosity-average molecular weight (Mz) of at least 130,000, such as at least 150,000, at least 170,000, at least 200,000, at least 250,000, and at least 300,000; and between 130,000 and 300,000, such as between 150,000 and 270,000, between 170,000 and 250,000, and between 190,000 and 240,000.

A barrier layer that includes PVdC may also include a thermal stabilizer (e.g., a hydrogen chloride scavenger such as epoxidized soybean oil) and a lubricating processing aid (e.g., one or more acrylates).

Useful polyamides may include polyamide 6, polyamide 9, polyamide 10, polyamide 11, polyamide 12, polyamide 66, polyamide 610, polyamide 612, polyamide 6I, polyamide 6T, polyamide 69, copolymers made from any of the monomers used to make two or more of the foregoing homopolymers (e.g., copolyamide 6/12, polyamide 12, copolyamide 66/69/6I, copolyamide 66/610, copolyamide 6/66, and copolyamide 6/69), and blends of any of the foregoing homo- and/or copolymers. Polyamide copolymers include: (a) copolyamide 6/12 comprising (i) caprolactam mer in an amount of from about 20 to 80 weight percent (preferably 30 to 70 weight percent, more preferably 40 to 60 weight percent), and (ii) laurolactam mer in an amount of from about 80 to 20 weight percent; and (b) copolyamide 66/69/6I comprising 10 to 50 weight percent hexamethylene adipamide mer (preferably from about 20 to 40 weight percent), 10 to 50 weight percent polyamide 69 mer (preferably from about 20 to 40 weight percent), and 10 to 60 weight percent hexamethylene isophthalamide mer (preferably, from about 10 to 40 weight percent).

In some embodiments, the lidstock may also comprise one or more additional layers or films including one or more sealant layers, tie layers, bulk layers, etc. In some embodiments, the lidstock may comprise a trap-printable laminate having barrier properties. Such laminates are discussed in greater detail in U.S. Pat. Nos. 6,627,273 and 6,769,227, the contents of which are hereby incorporated by reference.

As shown in FIG. 1, the package 10 may include a time-temperature indicator 20 that is disposed in a temperature monitoring relationship with the package. As discussed above, meat products packaged in a low oxygen atmosphere comprising carbon monoxide may have an appearance of freshness due to the formation of carboxymyoglobin within the meat. In some cases, the packaged meat product may have been exposed to a time-temperature event that may result in spoilage. In such cases, the use of an expiration date and/or the appearance of the meat product may not accurately reflect whether the meat product has spoiled. The use of the time-temperature indicator may permit a retailer or consumer to more accurately determine if the packaged product has spoiled. In one alternative embodiment, the time-temperature indicator may be configured to change color in response to a temperature-exposure event. In the context of the invention, a “temperature-exposure event” refers to an instance where the temperature may have exceeded a predetermined minimum or maximum for the particular perishable product being monitored.

The exact nature of a temperature monitoring relationship can vary depending upon the environment in which the package is disposed. For instance, in some cases the package may be disposed in an environment where there is minimal variation in the temperature. In this type of environment, the time-temperature indicator may be disposed at a greater distance from the package without compromising the uniformity in exposure of the time-temperature indicator. In other environments the temperature may fluctuate from point-to-point. To ensure uniformity in exposure in this type of environment, it may be desirable to position the time-temperature indicator in close proximity to the package being monitored. In embodiments where the package includes an insulation layer, it may be desirable to position the time-temperature indicator on the same side of the insulation layer as the package is positioned.

Time-temperature indicators that may be used in the invention include a broad range of devices that can visually indicate a cumulative time-temperature exposure or temperature history of an object being monitored. In some embodiments, the time-temperature indicator may be read with an instrument, such as a Minolta CR 300 Chroma Meter. Time-temperature indicators may indicate that a temperature threshold may have been exceeded by producing a visual physical change, such as a change in color. Time-temperature indicators may use a mechanical, chemical, electrochemical, enzymatic, or microbiological change to indicate through a visible response that a predetermined threshold may have been exceeded. The visible response may be expressed in the form of a mechanical deformation, color development, or color movement. In some embodiments, the time-temperature indicator may use a diffusion based indicator, enzymatic indicator, or polymerization based indicator.

Time-temperature indicators may be configured to show a visual change at a predetermined time-temperature threshold. The predetermined threshold for the time-temperature indicator may be the same or different than the expiration threshold of the package being monitored. In one embodiment, an appropriate time-temperature indicator can be selected based on the products spoilage rate as a function of one or more of the following conditions: 1) the initial spoilage type; 2) the initial microbial level in the product; and 3) expected storage temperature of the product. For instance, gram positive bacteria on fresh beef and pork products packaged in a low oxygen environment may be expected to have microbial plate count of about 10⁷-10⁸ colony forming units/gram (cfu/gm) after about 2 months, whereas gram negative bacteria growing in an aerobic package environment may have a putrid odor within a period of several days and a microbial count of about 10⁶ cfu/gm. In one embodiment, based on the above considerations, the expiration of the TTI may be selected to correlate with a microbial plate count of about 10⁷-10⁸ cfu/gm. In other embodiments, the TTI expiration may be selected to expire when the microbial plate count is greater than 10⁶ cfu/gm. The time to spoilage is also a function of the initial level of bacteria on the product. Since one objective of using a TTI may be to avoid marketing a spoiled or unsafe product, it may be desirable in some embodiments to select a TTI with a performance target that is conservative in its prediction of time to an unacceptable product.

The time-temperature indicator in some embodiments may include an adhesive substrate that can be used to mount or position the time-temperature indicator in a temperature monitoring relationship with a package. Time-temperature indicators having an adhesive substrate layer are commonly referred to as time-temperature indicator labels. In alternate embodiments, the time-temperature indicator label can be attached to a package using, for example, tape, glue, mechanical fasteners, and the like. Preferably, the time-temperature indicator label may be easily activated by a user at the start of temperature monitoring.

In some embodiments, the time-temperature indicator label can produce a visual response immediately after being exposed to a predetermined temperature. In other embodiments, the time-temperature indicator label may produce a visual response only after prolonged exposure to the predetermined temperature. In still other embodiments, the time-temperature indicator label may produce a scaled visual change that can be compared to a reference scale. The scale can be used to make an initial determination of the duration and extent of temperature exposure. Exemplary time-temperature indicator devices are described in U.S. Pat. Nos. 5,368,905; 5,057,434; 5,667,303; 5,709,472; 6,042,264; and 6,544,925.

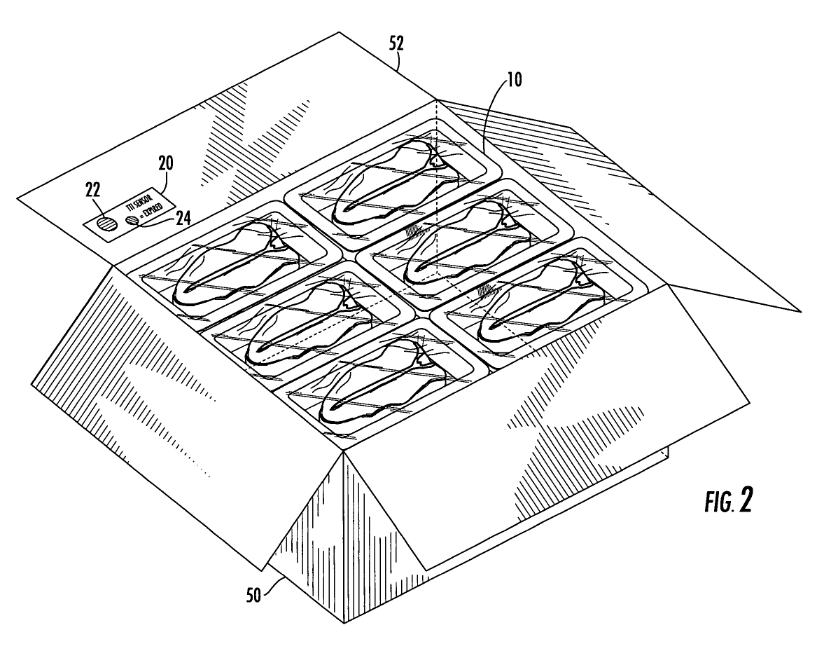

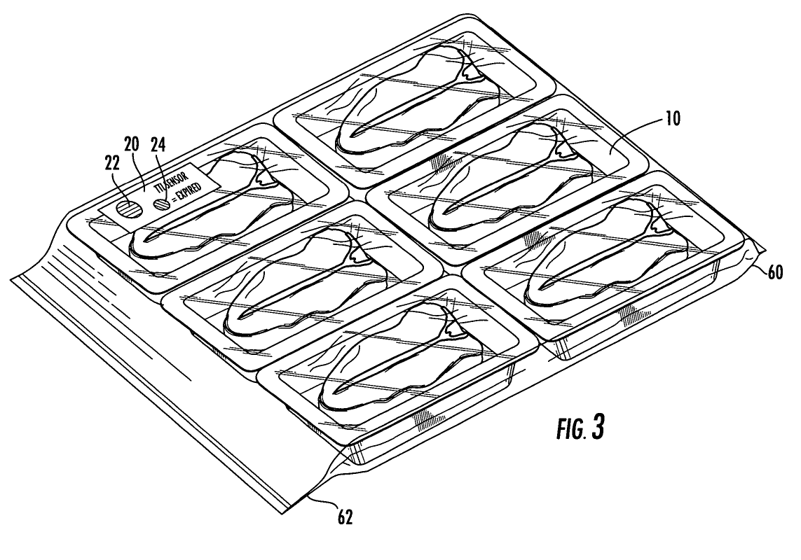

In one alternative embodiment, a time-temperature indicator may be used to monitor the time-temperature exposure for a plurality of packaged products having a modified atmospheres comprising carbon monoxide. In this regard, FIGS. 2 and 3 illustrate alternative embodiments wherein a time-temperature indicator is disposed in a monitoring relationship with more than one package 10. In FIG. 2, a time-temperature indicator 20 is disposed in the interior space of a carton 50 containing multiple packages 10. Preferably, the time-temperature indicator is disposed in the carton in a location that may be easily visualized by a person opening the carton. Here, the time-temperature indicator is illustrated as being attached to an inner flap 52 or opening of the carton. Upon opening the carton, the time-temperature indicator may permit a person to quickly ascertain whether the contents of the carton may have been exposed to a temperature exposure above a predetermined threshold. In some embodiments, the time-temperature indicator may be disposed on an exterior surface of the carton provided that a temperature monitoring relationship is maintained between the plurality of packages and the time-temperature indicator. In the event a time-temperature threshold has been exceeded, a person receiving the carton may decide whether to discard or reject the packaged items. In the context of the invention, the term “carton” also includes box, container, bag, master-bag, shipper, receptacle, and the like that may be used to package one or more modified atmosphere packages 10.

In FIG. 3 a time-temperature indicator is depicted as being used in conjunction with a flexible packaging 60, such as a “master-bag”, in which a plurality of packages 10 may be disposed. Similar to the carton described above, the flexible packaging 60 may include a time-temperature indicator that has been disposed in a temperature monitoring relationship with one or more packages disposed within the flexible packaging. Flexible packaging 60 may include an opening 62 that may be sealed or folded after one or more packages 10 have been inserted into the opening. In some embodiments, the flexible packaging may include oxygen barrier properties. In one alternative embodiment, the interior of the flexible packaging may also include a modified atmosphere comprising a mixture of gases including carbon monoxide. The use of the time-temperature indicator may permit a retailer to quickly determine if the contents of the flexible packaging may have been exposed to a temperature exposure event before the package is place into the retail display case for sale. As a result, the possibility of placing a spoiled product in a retail display case may be reduced.

In one alternative embodiment, the time-temperature indicator may include a scaled response that may permit a determination of the remaining shelf-life of a packaged product. The shelf-life of a product refers to the length of time that the product can be stored before there is a possibility of deteriorating quality or running a risk of health hazard. A product may be considered expired after its shelf-life has been depleted. In some embodiments, the shelf-life may be calculated in days. Shelf-life may be dependent upon the nature of the product itself, the age of the product, the environmental conditions to which it has been exposed, and the duration of any such exposure. Some products may have a default shelf-life for a certain amount of days when stored under certain environmental conditions, such as temperature. The default shelf-life refers to the expected shelf-life of a product when stored under certain predefined environmental parameters. In some cases, the default shelf-life can be shortened depending upon the environmental conditions to which the item has been exposed. For example, in some circumstances, the temperature to which a product has been exposed may exceed a desired value for the product. The resulting shelf-life may be affected by the duration and magnitude of the exposure. If the duration of the exposure is for a brief period of time, and the magnitude is relatively small, the shelf-life may only be minimally affected. In some cases, a short duration may cause the shelf-life to expire if the magnitude is significant. In some embodiments, the time-temperature indictor may include a scaled-response that may permit a person to determine if the product has been exposed to a time-temperature exposure that may have increased the likelihood of spoilage and/or reduced the remaining shelf-life of the product.

A second aspect of the invention is directed to a method of using a time-temperature indicator to indicate the likelihood that spoilage may have occurred in the package. In one embodiment, the method may comprise packaging a food product, such as raw meat, in a modified atmosphere package comprising 0.1 to 1 vol. % carbon monoxide; associating a time-temperature indicator in a temperature monitoring relationship with the package; activating the time-temperature indicator; and visually inspecting the time-temperature indicator to determine if the package has been exposed to a temperature exposure that may have increased the likelihood of spoilage of the packaged product. The time-temperature indicator may be activated before or after it has been associated with the package.

Inspection of the time-temperature indicator may occur at various points throughout the distribution and retail sale system. For example, in one embodiment, the package may be stored before being shipped to the retailer or distributor. Before shipment or receipt of the shipped package, the time-temperature indicator may be inspected to determine if the time-temperature indicator has expired. In the event the time-temperature indicator has expired, the package may be rejected and/or disposed of before shipment. In some embodiments, a retailer may inspect the time-temperature indicator before placing the package in a retail display case at the point-of-sale. As discussed above, the use of the time-temperature indicator may help reduce the chance of selling a spoiled product. In some embodiments, the retailer may periodically inspect the displayed packages to ensure that the packages have not been exposed to a temperature exposure that may cause spoilage of the product.

In one embodiment, packaging the perishable food product comprises placing the perishable food product into the interior space of a tray or support member; evacuating the atmosphere from the interior of the package; flushing the interior with a mixture of gases comprising 0.1 to 3 vol. % carbon monoxide to produce a low oxygen atmosphere; and attaching a lidstock to the support member to enclose the food product in the low oxygen atmosphere. In some embodiments, the support member and lidstock may be substantially oxygen impermeable so that a low oxygen atmosphere within the package may be maintained.

In one alternative embodiment, the method may also comprise placing a plurality of the packages in a carton or master-bag and associating a time-temperature indicator with the carton. The time-temperature indicator may then be used to determine if the plurality of packages may have been exposed to a temperature exposure that exceeds a predetermined threshold. In some embodiments, the carton or master-bag may then be shipped to a retailer. Before removing and/or placing the packages for sale, the retailer may visually inspect the time-temperature indicator to determine if there is an increased likelihood of spoilage.

If visual inspection of the time-temperature indicator does not indicate that a temperature event may have occurred, the packaged products can be processed in the normal course of business. The normal course of business refers to the manner in which acceptable products would normally be treated or handled. For instance, it could refer to continued storage of the package, shipment of the package, sale of the package, or acceptance of the package.

### EXAMPLES

The following examples are included for the purpose of illustrating the invention and should not be construed to be limiting.

In this example, a time-temperature indicator was disposed in a temperature monitoring relationship with a packaged red meat product having a modified atmosphere comprising 0.4 vol. % carbon monoxide. The expiration of the time-temperature indicator was correlated against microbial growth on the meat product to determine the usefulness of a time-temperature indicator for indicating possible spoilage of the packaged meat product. The time durations and temperature and storage parameters were chosen to approximate real-life storage and display conditions to which a meat product may be subjected.

### Example 1

A 25 day old Longissmus dorsi_subprimal beef product was cut into ¾″ strip steaks and packaged in a modified atmosphere on a Ross Impact 3320 Packaging system. The package comprised a barrier tray having a volume of 650 cc. The lidstock comprised barrier film having an oxygen transmission rate of less than 10 cc at STP/m²/24 hr/atm. The modified atmosphere comprised 0.4 vol. % carbon monoxide, 20 vol. % carbon dioxide, and the remaining balance comprised of nitrogen. A time-temperature indicator from Avery Denison, model number 35/15, was used in the experiment.

The packaged meat product was held in dark storage for 3 days at a temperature of about 30 to 31° F. The packaged product was then removed from dark storage and placed in a lighted display case maintained at about 40° F. The packaged meat was analyzed daily for color, total aerobic plate count, the TTI was judged to be either expired or unexpired, and microbial count. In this example, an unactivated TTI had a yellow color and an expired TTI had a pink color.

TABLE 1

| | | Aerobic | | Visual | |
|---|---|---|---|---|---|
| | Storage | Plate | Lean | Appearance | |
| Test | Temperature | count (log | Tissue | of the | State of |
| Day | (° F.) | cfu/g)** | a value* | Meat | TTI |
| 1 | 30 | 4.1 | 21.5 | Cherry red | unexpired |
| 2 | 30 | — | — | — | — |
| 3 | 30 | 3.7 | 21.4 | Cherry red | unexpired |
| 4 | 40 | 3.8 | 23.1 | Cherry red | unexpired |
| 5 | 40 | 4.1 | 22.4 | Cherry red | unexpired |
| 6 | 40 | 5.2 | 23 | Cherry red | expired |
| 7 | 40 | 5.9 | 23 | Cherry red | expired |
| 8 | 40 | 6.9 | 21.2 | Cherry red | expired |

*Measured with a Minolta CR 300 Chroma Meter. An increase in the a value generally represents an increase in redness, neutral color would be about a = 0.
**Measured using a 3M Petri film.

It can be seen from the above data that a time-temperature indicator may be used to approximate the spoilage behavior of a meat product packaged in modified atmosphere comprising carbon monoxide. The time-temperature indicator used in the above experiment is primarily designed to approximate the spoilage behavior of seafood. A plate count above about 10⁷ to 10⁸ is normally considered indicative of spoilage of red meat products in a low oxygen environment with 20% carbon dioxide. In the above example, the time-temperature indicator expired at a plate count of about 5.9 log cfu/gm, which indicates that the particular time-temperature indicator may be too conservative. In some embodiments, the time-temperature indicator may be formulated to expire when the aerobic plate count is about 10⁷ cfu/gm.

### Example 2

A Longissmus dorsi subprimal beef product was cut into steaks and packaged in a modified atmosphere on a Ross Impact 3320 Packaging system. The package comprised a barrier tray having a volume of 650 cc. The lidstock comprised barrier film having an oxygen transmission rate of less than 10 cc at STP/m²/24 hr/atm. The modified atmosphere comprised 0.4 vol. % carbon monoxide, 30 vol. % carbon dioxide, and the remaining balance comprised nitrogen. A time-temperature indicator from Avery Denison, model number 35/15, was used in the experiment.

The packaged meat product was held in dark storage for 17 days at a temperature of about 30 to 31° F. The packaged product was then removed from dark storage and placed in a lighted display case maintained at about 40° F. Upon removal from dark storage the package was judge for state of TTI, visual appearance, and aerobic plate value.

TABLE 2

| | Day | Day | Day |
|---|---|---|---|
| | 17 + 0 | 17 + 3 | 17 + 4 |
| State of TTI | unexpired | unexpired | expired |
| Visual appearance of the | Cherry red | Cherry red | Cherry red |
| meat product | | | |
| Lean Tissue Hunter a value | 17.2 | 19.4 | 17.7 |
| Aerobic Plate count (log | 4.5 | 6.3 | 5.9 |
| cfu/g)** | | | |

*Measured with a Minolta CR 300 Chroma Meter. An increase in the a value generally represents an increase in redness, neutral color would be about a = 0.
**Measured using a 3M Petri film.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A modified atmosphere package comprising:
a substantially oxygen impermeable package having an interior space configured to enclose a food product therein, said interior space having a mixture of gases comprising at least 0.1 vol. % carbon monoxide and at least one other gas to form a low oxygen environment; and
a time-temperature indicator disposed in a temperature monitoring relationship with said package.

2. A modified atmosphere package according to claim 1, wherein the time-temperature indicator is disposed on an exterior surface of said package.

3. A modified atmosphere package according to claim 1, wherein a red meat product is disposed in the interior of said package.

4. A modified atmosphere package according to claim 1, wherein the time-temperature indicator changes color when subjected to undesired temperature conditions, undesired time durations, or a combination thereof.

5. A modified atmosphere package according to claim 1, wherein said modified atmosphere comprises about 30 vol. % carbon dioxide, from about 0.1 to 5 vol. % carbon monoxide, and a balance nitrogen.

6. A modified atmosphere package according to claim 1, wherein said modified atmosphere comprises from about 0.1 to 3 vol. % carbon monoxide.

7. A modified atmosphere package according to claim 1, wherein said package is disposed in an interior of a carton containing a plurality of such packages and wherein said time-temperature indicator is disposed in the interior of said carton.

8. A modified atmosphere package according to claim 1, wherein said time-temperature indicator is formulated to expire when a food product disposed in said package has an aerobic plate count that is about 6 log cfu/gm or greater.

9. A modified atmosphere package according to claim 1, wherein said time-temperature indicator changes visual appearance based on a combination of predetermined times and temperatures, and wherein said change in visual appearance is selected from the group consisting of a mechanical deformation, mechanical movement, color change, color movement, and combinations thereof.

10. A modified atmosphere package for sealing a food product therein, said package comprising:
a support member having an interior space for disposing a food product therein;
a barrier layer attached to said support member and sealably enclosing a food product in said interior space;
a modified atmosphere in said interior space comprising a low oxygen atmosphere having from about 0.1 to 3 vol. % carbon monoxide; and
a time-temperature indicator disposed in a temperature monitoring relationship with said package.

11. A modified atmosphere package according to claim 10, wherein the barrier layer comprises a barrier layer having an oxygen transmission rate no greater than 10 cc at STP/m²/24 hr/atm.

12. A modified atmosphere package according to claim 10, wherein a beef or pork product is disposed in the interior space.

13. A modified atmosphere package according to claim 10, wherein the time-temperature indicator is adhesively attached to an exterior surface of said package.

14. A modified atmosphere package according to claim 10, wherein the time-temperature indicator changes color when subjected to undesired temperature conditions, undesired time durations, or a combination thereof.

15. A modified atmosphere package according to claim 10, wherein the time-temperature indicator is formulated to produce a scaled visual change in response to a time-temperature exposure above a predetermined threshold.

16. A modified atmosphere package according to claim 10, wherein the modified atmosphere comprises about 0.4 vol. % carbon monoxide.

17. A method of evaluating the likelihood of spoilage in a carbon monoxide modified atmosphere package comprising:
packaging a perishable food product in a package comprising a low oxygen atmosphere and about 0.1 to 5 vol. % carbon monoxide;
placing a time-temperature indicator in a temperature monitoring relationship with said package;
activating said time-temperature indicator; and
inspecting the time-temperature indicator at least once to determine if said package has been exposed to a time-temperature exposure above a predetermined threshold that increases the likelihood of spoilage in the food product.

18. A method according to claim 17, wherein the step of placing a time-temperature indicator in a temperature monitoring relationship further comprises attaching the time-temperature indicator to an exterior surface of said package.

19. A method according to claim 17, wherein the step of inspecting the time-temperature indicator is preceded by one or more of storing, shipping, or displaying the package.

20. A method according to claim 17, further comprising the step of rejecting the package if the step of inspecting the time-temperature indicator indicates the likelihood that the package has been exposed to a time-temperature exposure above a predetermined threshold.

21. A method according to claim 17, wherein the step of packaging a food product further comprises the steps of
placing a raw meat product in an interior of a barrier support member;
evacuating the atmosphere from said interior;
flushing said interior with a mixture of gases to provide a low oxygen atmosphere comprising from about 0.1 to 3 vol. % carbon monoxide; and
attaching a substantially oxygen impermeable lidstock to the support member to enclose the meat product therein.

22. A method according to claim 17, further comprising:
placing a plurality of said modified atmosphere package and a time-temperature indicator into an interior space of a carton; and
shipping the carton; and
inspecting the time-temperature indicator to determine if the contents of the carton have been exposed to a time-temperature exposure above a predetermined threshold.
